(19) United States
(12) Patent Application Publication
(10) Pub. No.: US 2022/0390096 A1
(43) Pub. Date: Dec. 8, 2022

(54) LIGHTING FIXTURE WITH TRANSPARENT ANTENNAS AND HEAT SPREADERS

(71) Applicant: WIRELESS NETWORK SITES TECHNOLOGY S.R.L., Rome (IT)

(72) Inventor: Silvia CUTINI, Rome (IT)

(73) Assignee: WIRELESS NETWORK SITES TECHNOLOGY S.R.L., Rome (IT)

(21) Appl. No.: 17/776,764

(22) PCT Filed: Nov. 11, 2020
(86) PCT No.: PCT/IT2020/050278

§ 371 Date: May 13, 2022

(30) Foreign Application Priority Data
Nov. 13, 2019 (IT) 102019000020838

(51) Int. Cl. F21V 29/507; F21V 23/00; H01Q 1/00; H01Q 1/12

(52) U.S. Cl. CPC F21V 29/507; F21V 23/005; H01Q 1/002; H01Q 1/12

(57) ABSTRACT

A lighting fixture with transparent antennas and heat spreaders, including: conductive portions made with conductive materials, and non-conductive portions made with non-conductive materials; one or more free spaces, enclosed between said conductive portions and the non-conductive portions; one or more anchor points, positioned inside said free spaces, for fixing one or more mechanical adapters; one or more electricity supply interfaces, positioned inside said free spaces, for electrically powering the lighting fixture with an available power supply; a removable and optically transparent screen, including non-conductive elements, made with non-conductive materials, and conductive elements, made with conductive materials, the screen being equipped with optically transparent antennas, metallized through holes, optically transparent transmission lines and optically transparent heat spreaders; a metallic outer frame protecting the optically transparent screen in which are positioned radio frequency connectors and connected to the optically transparent screen and to the optically transparent transmission lines.

### FIELD

This invention relates to a lighting fixture with transparent antennas and heat spreaders.

In particular, the invention relates to a lighting fixture of the so-called street lighting and/or street furniture type.

### BACKGROUND

As is known, lighting fixtures based on LEDs (Laser Emitting Diodes) are progressively replacing incandescent bulbs for household use, street lighting and urban environments, becoming in the last two cases mentioned focal points in the delivery of value-added technological services.

By way of example but exhaustive, these lighting fixtures can be installed at points for charging electric cars, parking meters, video surveillance sites etc., as described, for example, in patent documents U.S. Ser. No. 10/150,381 B2, U.S. Ser. No. 10/096,246 B2 and U.S. Ser. No. 10/187,557 B2).

It is also known how the paradigm of “Smart Cities” has become more and more established over recent years thanks to the availability of efficient and reliable data connections spread throughout the world, in particular thanks to the new 5G technology and its subsequent, upcoming, evolutions, see ITU-R M.2083.

These data connections allow the provision and management of smart services for the organisation and optimisation of public infrastructures and services as well as the implementation of environment protection policies by applying energy saving strategies. An example of this application is illustrated in CN102105002 A.

However, the growing number of radio base stations installed on the roofs of buildings and on the top of dedicated towers, which can be easily seen by the naked eye, lead, unfortunately, to a growing fear of technological installations by the final users, due to the known issues related to the electro-smog. This has lead to ever-increasing requests for installers to hide the structures, by means of camouflage techniques, for example as described in patent document JP3175698 B2.

In this context, a LED-based lighting fixture can advantageously be used as a focal point for the provision of smart services if it is capable of establishing wireless data connections, which can easily be used by a final user due to the widespread distribution of personal mobile devices (such as, for example, tablets, smartphones, etc.), in such a manner that it cannot be perceived as a risk factor for the health and safety of the final user (see the example in patent document JP3175698 B2).

However, the presence of high-tech electronic devices integrated in the LED-based lighting fixtures also results in significant problems with regard to heat dissipation and maintenance, both conservative and developmental, due to the increased complexity and consumption of these devices, resulting from the fast technological development of the market.

In order to overcome these drawbacks patent document US 2015/195892 A1 describes a lighting fixture comprising an antenna and heat spreaders, for dissipating the heat generated by said antenna.

### SUMMARY

The aim of the invention is to provide a lighting fixture which is able to overcome the above-mentioned drawbacks of the prior art.

In particular, the aim of the invention is to provide a lighting fixture equipped with antennas which improves the heat dissipation with respect to the prior art.

Moreover, an aim of the invention is that the lighting fixture equipped with antennas has a low visual impact on the surrounding environment.

Lastly, an aim of the invention is that the lighting fixture is simple, safe and reliable and with limited costs, both with regards to its production and its maintenance costs.

The object of the invention is therefore a lighting fixture with transparent antennas and heat spreaders, comprising:

conductive portions, made with conductive materials, and non-conductive portions, made with non-conductive materials;

one or more free spaces enclosed between said conductive portions and said non-conductive portions;

one or more anchor points, positioned within said free spaces, for fixing one or more mechanical adapters;

one or more electrical power supply interfaces, positioned within said free spaces, for electrically powering said lighting fixture with an available power supply;

one removable and optically transparent screen comprising non-conductive elements made with non-conductive materials, and conductive elements, made with conductive materials, said screen being equipped with optically transparent antennas, metallized through holes, optically transparent transmission lines and optically transparent heat spreaders;

one metallic outer frame protecting said optically transparent screen wherein radio frequency connectors are positioned and connected to said optically transparent screen and to said optically transparent transmission lines;

one thermal vice assembled on said metallic outer frame;

one plate supporting light sources and a relative driver, installed in the proximity of said light sources and connected to said light sources;

one or more grommets connecting between said free spaces and said optically transparent screen; and

one reference to the ground potential accessible through said metallic outer frame.

According to the invention, said lighting fixture can comprise a plurality of replaceable electronic modules, said replaceable electronic modules comprising said screen and/or electronic modules which can be installed in said free spaces.

Again according to the invention, said optically transparent screen can consist of five different layers:

two non-conductive layers, made of non-conductive, optically transparent, rigid materials, having variable thicknesses; and

three conductive layers made of conductive, optically transparent, flexible materials, having a constant thickness, wherein said conductive layers alternate with said two non-conductive layers.

In particular, according to the invention, said flexible transparent conductive layers with constant thickness can be made of flexible and non-conductive films, in particular thin flexible and non-conductive films, on which high conductivity grids are deposited, such as to form said optically transparent antennas, said optically transparent transmission lines and said optically transparent heat spreaders.

Moreover, according to the invention, said metallized through holes can pass through said conductive and non-conductive layers, being able to connect said high conductivity grids to the thermal vice and said metallic outer frame.

Further according to the invention, said conductive layers, said metallized through holes, said metallic outer frame and said thermal vice can allow the electrical and thermal connection of said driver and said electronic modules, when installed in said free spaces, with said transparent antennas and with said transparent heat spreaders.

Again according to the invention, said transparent antennas and said transparent heat spreaders can be such as to not alter the appearance of the lighting fixture, as it can be not directly visible to the naked eye.

Moreover, according to the invention, said transparent antennas are connected by transmission lines etched in each of said three conductive layers to the radio frequency connectors positioned on said metallic outer frame.

Again according to the invention, said transparent heat spreaders are connected by means of said metallic outer frame to said thermal vice, as they can be sized to increase the useful area for the heat exchange by convection and by conduction with the outside of said lighting fixture.

Lastly, according to the invention, said transparent heat spreaders and said thermal vice can be configured to allow the integration of said driver which powers, adjusts and controls said light sources in the proximity of said plate in which said light sources are installed, thus being able to increase the space available for the installation of electronic modules inside said free spaces of said lighting fixture.

### BRIEF DESCRIPTION OF THE DRAWINGS

The invention is now described, by way of example and without limiting the scope of the invention, with reference to the accompanying drawings, in which:

FIG. 1a shows a side view of a lighting fixture according to the invention for street furniture lighting, comprising light sources and a transparent screen inside of which are integrated antennas and heat spreaders, said transparent screen protecting the light sources;

FIG. 1b shows a cross-section side view of the lighting fixture of FIG. 1a, in which are visible free spaces and power supply adapters which can be used for the installation of optional electronic modules, using also the antennas and the heat spreaders integrated inside the transparent screen protecting the light sources;

FIG. 1c shows a side view of a lighting fixture according to the invention for street lighting, comprising light sources and a transparent screen inside of which are integrated antennas and heat spreaders, said transparent screen protecting the light sources;

FIG. 1d shows a cross-section side view of the lighting fixture of FIG. 1c, in which are visible free spaces and power supply adapters which can be used for the installation of optional electronic modules, using also the antennas and the heat spreaders integrated inside the transparent screen protecting the light sources;

FIG. 2a shows the FIG. 1b in which is highlighted the area comprising the screen for the light sources;

FIG. 2b shows a plan view of the area of the screen for the light sources;

FIG. 2c shows a cross-section view from above of the area of the screen of FIG. 2b, comprising transparent heat spreaders, transparent antennas and radiofrequency connectors installed on a metallic outer frame of the transparent screen, and a thermal vice and the LED driver positioned in the proximity of a plate of the metallic outer frame in which the light sources are installed;

FIG. 3a shows the FIG. 1b in which is highlighted the area comprising the screen for the light sources; and

FIG. 3b shows a transversal section of the area of the screen of FIG. 3a, showing conductive layers and dielectric layers which make up the transparent screen, metallized through holes which connect the conductive layers to the metallic outer frame and radio frequency connectors; it is also shown how the metallic outer frame is connected to earth and a thermal vice.

### DETAILED DESCRIPTION OF THE EMBODIMENTS

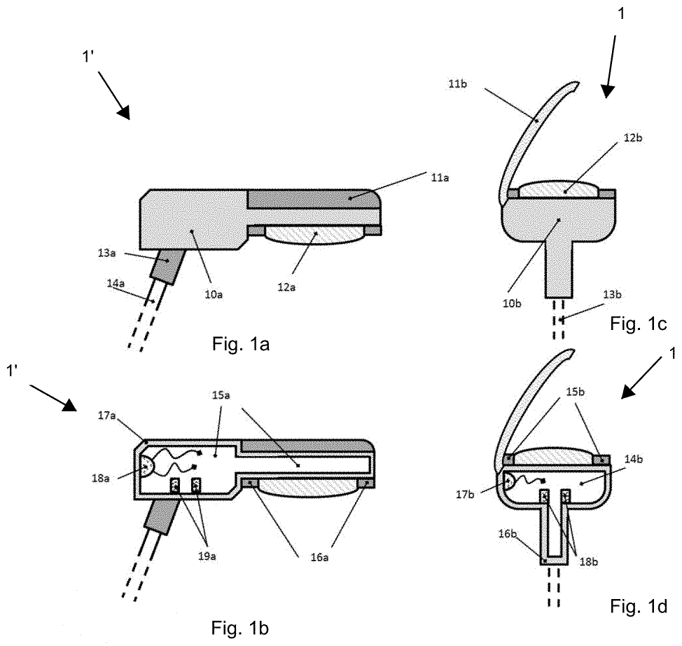

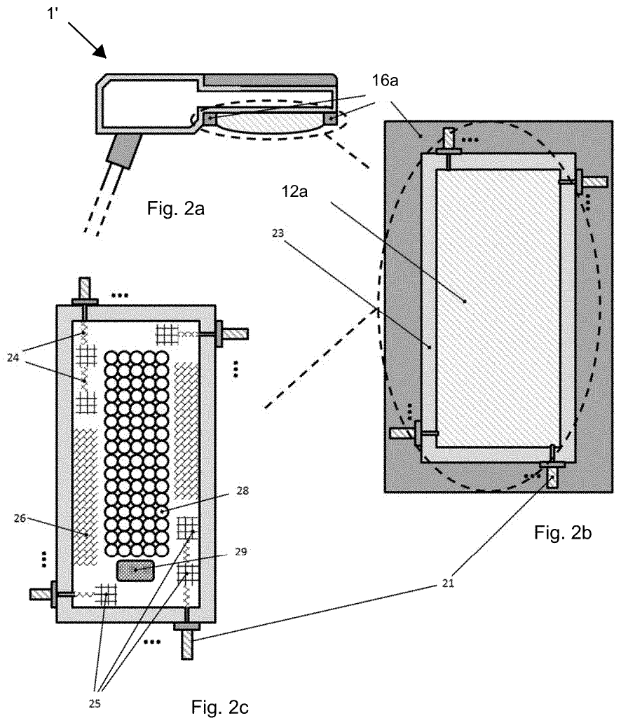

FIGS. 1 to 3 show a lighting fixture of the street lighting 1 or street furniture 1′ type, generically called lighting fixture 1; 1′ or lighting unit 1; 1′, made with conductive and non-conductive materials which surround empty spaces 15a; 14b or free spaces 15a; 14b or free compartments 15a; 14b. In particular, the conductive materials or conductors are electrically conductive materials. However, preferably, the materials are electrically and thermally conductive.

Said empty spaces 15a; 14b comprise inside them mechanical interfaces 19a; 18b and power supply connectors 18a; 17b prepared for the installation of optional and interchangeable electronic modules.

The lighting fixture 1; 1′ also comprises an outer frame 23 and a transparent screen 12a; 12b for protecting light sources 28, in particular LEDs, having integrated transparent antennas 25, transparent heat spreaders 35a, 35c and 35e, also called transparent heat dissipaters 35a, 35c and 35e or thermal dissipaters, and radio frequency connectors 21.

The transparent screen 12a; 12b, thanks to the integrated transparent antennas 25, the transparent heat spreaders 35a, 35c and 35e and the radio frequency connectors 21 can allow the implementation of wireless connectivity in the optional electronic modules installed in the empty spaces 15a; 14b, at the same time improving the thermal dissipation of the lighting fixture 1; 1′ and reducing the undesired perception of antennas in public areas.

In detail, the lighting fixture of street lighting 1 or street furniture 1′ type comprises conductive portions 11a, 13a, 16a, 15b, made with conductive materials, and non-conductive portions 10a, 10b, made with non-conductive materials.

The free spaces 15a; 14b are enclosed between the conductive portions 11a, 13a, 16a, 15b and the non-conductive portions 10a, 10b.

Moreover, inside the free spaces 15a; 14b there are one or more anchor points 19a; 18b, for fixing one or more mechanical adapters and one or more electrical power supply interfaces 18a; 17b, to electrically power the lighting fixture 1; 1′ with an available power supply source.

One or more grommets 17a; 17b are positioned for connecting between the free spaces 15a; 14b and the optically transparent screen 12a; 12b.

The free spaces 15a; 14b are in fact designed to house the optional electronic modules and prepared for their relative power supply.

As mentioned, the empty spaces 15a; 14b can be used for the installation of various replaceable electronic modules.

The replaceable electronic modules are optional and can comprise modules available on the market, which require wireless connectivity, power supply and high heat dissipation. The maintenance of said optional electronic modules may be carried out simply by replacing the relative mechanical adapters 19a; 18b, the relative power supply adapters 18a; 17b and/or the optically transparent screen 12a; 12b.

In detail, the optically transparent screen 12a; 12b can be replaced with one of the same shape factor but equipped with antennas with different electromagnetic characteristics (operating band, bandwidth, pointing etc) and thermal spreaders 35a, 35c and 35e with different thermal characteristics (heat exchange area, etc) or different metallic through holes, transmission lines and radio frequency connectors 21.

The optically transparent screen 12a; 12b is in fact removable and comprises non-conductive elements 35b; 35d, made with non-conductive materials, and conductive elements 35a; 35c, 35e, made with conductive materials. The screen 12a; 12b is equipped with said optically transparent antennas 25, metallized through holes 35f, optically transparent transmission lines 21, 23, 24 and optically transparent heat spreaders 35a, 35c and 35e.

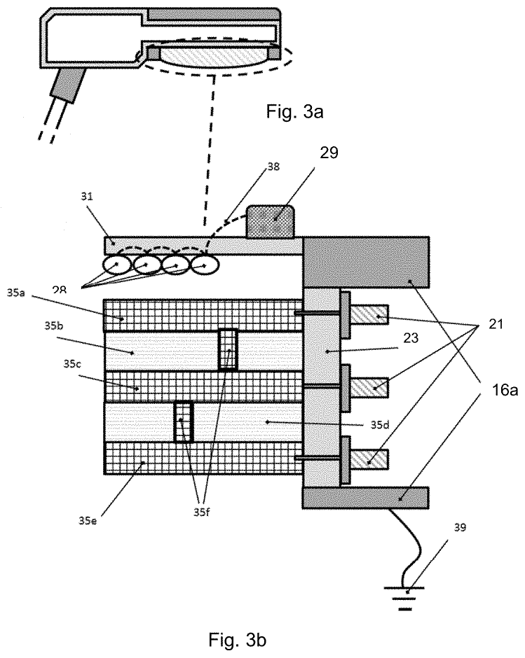

As shown in FIG. 3b, the optically transparent screen 12a; 12b can consist of five different layers:

two non-conductive layers 35b; 35d, made of non-conductive, optically transparent, rigid materials, having variable thicknesses;

three conductive layers 35a, 35c and 35e made of conductive, optically transparent, flexible materials, having a constant thickness, wherein said conductive layers 35a, 35c and 35e alternate with said two non-conductive layers 35b; 35d.

In particular, according to the embodiment of FIG. 3b, the flexible transparent conductive layers 35a, 35c and 35e with constant thickness are made of flexible and non-conductive films on which high conductivity grids are deposited, for example by means of ink-jet printing and/or 3D printing techniques, such as to form said optically transparent antennas 25, said optically transparent transmission lines 21, 23, 24 and said optically transparent heat spreaders 35a, 35c and 35e.

Moreover, metallized through holes can pass through said conductive layers 35a, 35c and 35e and said non-conductive layers 35b; 35d for connecting the high conductivity grids to the thermal vice 16a; 15b and to the metallic outer frame 23.

In particular, the conductive layers 35a, 35c and 35e, the metallized through holes, the metallic outer frame 23 and the thermal vice 16a; 15b allow the electrical and thermal connection of said driver 29 and of the optional electronic modules installed in said free spaces 15a; 14b, with said transparent antennas 25 and with said transparent heat spreaders.

Moreover, the transparent antennas and said transparent heat spreaders 35a, 35c and 35e are configured so as to not alter the appearance of the lighting fixture 1; 1′, and so as not to be directly visible to the naked eye.

The transparent antennas 24 are connected by transmission lines 25 etched in each of said three conductive layers 35a, 35c and 35e to the radio frequency connectors 21 positioned on said metallic outer frame 23.

The transparent heat spreaders 35a, 35c and 35e are in turn connected by means of the metallic outer frame 23 to said thermal vice 16a; 15b, as they are sized to increase the useful area for the heat exchange by convection and by conduction with the outside of the lighting fixture 1; 1′.

Lastly, the transparent heat spreaders 35a, 35c and 35e and said thermal vice 16a; 15b are configured to allow the integration of said driver 29 which powers, adjusts and controls the light sources 28 in the proximity of a plate 31 in which said light sources 28 are installed, thus increasing the space available for the installation of optional electronic modules inside the free spaces 15a; 14b.

The transparent screen 12a; 12b is in fact positioned to protect the plate 31 for housing LEDs 28 or light sources 28.

The plate 31 supports the light sources 28 and the relative driver 29, installed in the proximity of the light sources 28 and connected to them.

The plate 31 can also be integrated with the transparent screen 12a; 12b.

The light sources 28 are interconnected by means of connection means 38 to a power supply and control device 29, that is, to a driver 29 positioned in the proximity of the plate 31 which houses the light sources 28. The transparent screen 12a; 12b is interchangeable between several types with the same shape factor but equipped with heat spreaders 35a; 35c; 35e, through holes 35f, and transparent antennas 25 with different shapes and a different number of radiofrequency connectors 21.

The antennas 25 and the heat spreaders 35a; 35c; 35e can also be made with ink jet printing techniques (for example with the method illustrated in patent document US2019109381 A1) and 3D printing techniques (for example with the method illustrated in patent document CN104559196 B), based on conductive inks and particulates which allow the formation of thin and optically transparent layers by using conductive grids, which reduce the transmission of the dielectric matrix by values of even less than 10% (for example as illustrated in patent document US2019110360 A1). The plate 31 which houses the LEDs 28 can in this way be positioned in the proximity of the driver 29 as a result of the increased thermal dissipation capacity, increasing in this way the space available for housing the optional electronic modules.

One thermal vice 16a; 15b is assembled on the metallic outer frame 23. The integration of transparent heat spreaders and transparent antennas inside the transparent screen 12a; 12b of the lighting fixture 1; 1′, which is equipped with a protective metallic outer frame 23, a thermal vice 16a; 15b and the plate 31 on which are installed the light sources 28 (that is, the LEDs 28) and the relative driver 29 positioned in the proximity of the plate 31 where the LEDs 28 are positioned, is such as to:
not alter the appearance of the lighting fixture 1; 1′;
not allow the users to perceive the presence of antennas 25 immediately nearby;
increase the surface area suitable for installation of antennas 25 on the lighting fixture 1; 1′;
increase the surface area useful for heat exchange between the inside and outside of the lighting fixture 1; 1′;
allow the installation of optional electronic modules without affecting its lighting functions and its thermal dissipation capacity;
allow an easy conservative and developmental maintenance simply by replacing the transparent screen 12a; 12b and the optional electronic modules; and
maximise the space available inside the lighting fixture 1; 1′ for the installation of the optional electronic modules thanks to the greater thermal dissipation capacity and the driver 29 positioned in the proximity of the LEDs 28 or light sources 28.

The metallic outer frame 23 is, as mentioned, positioned for protecting the optically transparent screen 12a; 12b inside of which the connectors 21 are positioned, in particular radio frequency connectors 21, connected to the optically transparent screen 12a; 12b and to the optically transparent transmission lines 21, 23 and 24.

One reference to the ground potential 39 is made accessible through the metallic outer frame 23.

Lastly, the lighting fixture 1; 1′ may be equipped with reflective screen 11b, and may be designed for fixing on existing supporting structures 14a, 13b.

The preferred embodiments have been described above and variants to the invention have been suggested, but it shall be understood that the invention may be modified and/or adapted by experts in the field without thereby departing from the scope of the inventive concept, as defined in the claims herein.

1-10. (canceled)

11. A lighting fixture with transparent antennas and heat spreaders, comprising:
conductive portions, made with conductive materials and non-conductive portions, made with non-conductive materials;
one or more free spaces enclosed between said conductive portions and said non-conductive portions;
one or more anchor points, positioned within said free spaces, for fixing one or more mechanical adapters;
one or more electrical power supply interfaces, positioned within said free spaces, for electrically powering said lighting fixture with an available power supply;
one removable and optically transparent screen comprising non-conductive elements made with non-conductive materials, and conductive elements, made with conductive materials, said screen being equipped with optically transparent antennas, metallized through holes, optically transparent transmission lines and optically transparent heat spreaders;
one metallic outer frame protecting said optically transparent screen wherein radio frequency connectors are positioned and connected to said optically transparent screen and to said optically transparent transmission lines;
one thermal vice assembled on said metallic outer frame;
one plate supporting light sources and a relative driver, installed in the proximity of said light sources and connected to said light sources;
one or more grommets connecting between said free spaces and said optically transparent screen; and
one reference to the ground potential accessible through said metallic outer frame.

12. The lighting fixture according to claim 11, further comprising a plurality of replaceable electronic modules, said replaceable electronic modules comprising said screen and/or electronic modules which can be installed in said free spaces.

13. The lighting fixture according to claim 11, wherein said optically transparent screen is made of five different layers, including:
two non-conductive layers, made of non-conductive, optically transparent, rigid materials, having variable thicknesses; and
three conductive layers made of conductive, optically transparent, flexible materials, having a constant thickness, wherein said conductive layers alternate with said two non-conductive layers.

14. The lighting fixture according to claim 13, wherein said flexible transparent conductive layers with constant thickness are made of flexible and non-conductive films on which high conductivity grids are deposited, to form said optically transparent antennas, said optically transparent transmission lines and said optically transparent heat spreaders.

15. The lighting fixture according to claim 14, wherein said metallized through holes pass through said conductive and non-conductive layers, connecting said high conductivity grids to the thermal vice and said metallic outer frame.

16. The lighting fixture according to claim 15, wherein said conductive layers, said metallized through holes, said metallic outer frame and said thermal vice allow the electrical and thermal connection of said driver and said electronic modules, when installed in said free spaces, with said transparent antennas and with said transparent heat spreaders.

17. The lighting fixture according to claim 11, wherein said transparent antennas and said transparent heat spreaders do not alter the aesthetics of the lighting fixture and they are not directly visible to the naked eye.

18. The lighting fixture (according to claim 13, wherein said transparent antennas are connected by transmission lines etched in each of said three conductive layers to the radio frequency connectors positioned on said metallic outer frame.

19. The lighting fixture according to claim 13, wherein said transparent heat spreaders are connected by means of said metallic outer frame to said thermal vice, being sized to increase the useful area for the heat exchange by convection and by conduction with the outside of said lighting fixture.

20. The lighting fixture according to claim 11, wherein said transparent heat spreaders and said thermal vice are configured to allow the integration of said driver which powers, adjusts and controls said light sources in the proximity of said plate in which said light sources are installed, thus increasing the space available for the installation of electronic modules inside said free spaces of said lighting fixture.
